(19) United States
(12) Patent Application Publication
(10) Pub. No.: US 2021/0129258 A1
(43) Pub. Date: May 6, 2021

(54) CUTTING AND WELDING TORCHES

(71) Applicant: The ESAB Group Inc., Florence, SC (US)

(72) Inventor: Andrew Raymond, Lebanon, NH (US)

(21) Appl. No.: 16/668,364

(22) Filed: Oct. 30, 2019

(51) Int. Cl. B23K 10/00

(52) U.S. Cl. CPC B23K 10/006

(57) ABSTRACT

Disclosed are cutting and welding torches wherein one or more gas conduits are situated butting against an inner surface of a wall of a torch body or that are formed at least in part by an inner surface of the wall of the torch body. According to other implementations, the one or more gas conduits are formed entirely inside one or more walls of the torch body.

### TECHNICAL FIELD

The present disclosure relates to cutting and welding systems, and more particularly to apparatus and methods for directing gas flow through a body of a cutting or welding torch.

### BACKGROUND

The provision of gas flow through a body of a cutting or welding torch has traditionally occurred through conduits located inside the body at distances away from the inner walls of the body. Such configurations limit the available space inside the body for the placement of additional electronics and/or additional gas conduits. Further developments of cutting and welding torches are hence restricted by the space constraint imposed by the traditional method of routing gas conduits through such devices.

### SUMMARY

To solve the aforementioned problem, cutting and welding torches are provided that include one or more gas conduits located against an inner surface of a wall that forms the body of the torches, and/or one or more gas conduits formed in part by an inner surface of the torch body wall and/or one or more gas conduits located entirely inside the torch body wall. According to some implementations, the torch bodies have a handle portion that is configured to be gripped by a hand of a human user and the one or more gas conduits are located inside the handle portion. As expressed above, the one or more gas conduits can be formed separately from the torch body and installed against an inner wall of the torch body or can be formed integrally with the torch body being located inside the wall of the torch body. According to some implementations, the one or more gas conduits are partially or fully defined by a portion of the torch body, as this provides the greatest benefit in terms of space reduction. However, according to some implementations, the gas conduits are defined entirely by structures coupled to an inner surface of the torch body.

A torch body implementing these concept may include one conduit on one side of the torch body or may include multiple gas conduits spaced apart from one another around an inner circumference of the torch body. The gas conduits can be used to transfer process gas (during plasma cutting), coolant gas (for cutting or welding), shield gas (for cutting or welding), or any other type of gas or combination of gases to the torch head.

According to one example, when these concepts are incorporated into a plasma torch, a first conduit on a first side of the plasma torch body can pass process gas (i.e., plasma gas) to the torch head (e.g., a cartridge of consumables) and a second conduit on a second side of the plasma torch body can pass shield gas to the torch head. To ensure gas does not leak between the handle and the components of the torch head, the torch body may comprise two halves (e.g. clam shell halves) that are clamped about a portion of the torch head. The inner circumference ends of these clamshell halves may also include a gasket to prevent leaks between the torch head and the torch body. However, it is also possible to couple the torch head to a torch body that includes gas channels in a number of other ways.

According to some implementations, the proximal end of the one or more gas conduits may be coupled to one or more gas conduits located inside a cable hose connected to one or more gas supplies by use of one or more quick connect/disconnect fittings.

As mentioned above, passing the gas in or adjacent the body of the handle frees up more space inside the handle. For example, these conduits can replace gas hoses extending through a central part of the torch body. Traditionally, these gas hoses have an outer diameter of up to or greater than ¼ inch. By virtue of the types of gas conduits provided herein, the space traditionally occupied by gas conduits is free for the placement of electronics, electrical connections, new/additional components, etc. Alternatively, this space may be eliminated to allow the overall size of the torch body to be decreased.

Additionally or alternatively, the torch body gas conduits can be used to introduce additional gas flows to the torch head and (a) allow a torch to use new features, such as shielding gas for a single gas torch, and/or (b) allow the torch to use different compositions of gas as compared to traditional operations. That is, the gas conduits may supplement traditional gas delivery elements, such as gas hoses that transfer gas from a cable hose (which connects the torch to a power supply) to the torch head, instead of replacing them.

These and other advantages and features will become evident in view of the drawings and detailed description.

### BRIEF DESCRIPTION OF THE DRAWINGS

FIG. 1 is a perspective view of a cutting system according to one implementation.

FIG. 2A is a side view of a torch according to one implementation.

FIG. 2B is a top view of the torch shown in FIG. 2A.

FIG. 3 is a cross-section side view of a head portion of a plasma torch according to one implementation.

FIG. 4A is a cross-sectional view of a portion of the plasma torch of FIG. 2A along line A-A with gas conduits being fixed directly to inner surfaces of a wall that forms the torch body.

FIG. 4B is an internal side view of the first part of the torch body shown in FIG. 4A along line C-C with the proximal end of the gas conduit including a gas fitting suitable for connecting the gas conduit to a gas supply.

FIG. 5A illustrates two halves of a torch body with each halve having formed in an internal surface a groove through which gas is passed.

FIG. 5B shows the configuration of FIG. 5A, with impervious members formed around and along a length of each of the grooves to form inside the torch body gas conduits.

FIG. 5C illustrates a detailed view of the impervious members shown in FIG. 5B

FIG. 5D shows a side view along lines B-B of FIG. 5B facing towards the inner surface of a wall that forms the torch body, with the elongate impervious member situated fix to the wall to form with the groove the gas conduit.

FIG. 5E is a variant of FIG. 5D, wherein a gas fitting is fluidly coupled to the proximal end of the gas conduit.

FIG. 6 is a cross-sectional view of a portion of the plasma torch of FIG. 2A along line A-A with gas conduits being formed entirely within the wall that forms the torch body.

### DETAILED DESCRIPTION

For discussion purposes, the disclosure that follows is primarily directed to plasma cutting torches, but is nonetheless applicable to welding torches and to other types of cutting torches in which one or more gas conduits are used to deliver gas through a handle portion of a body of the torches.

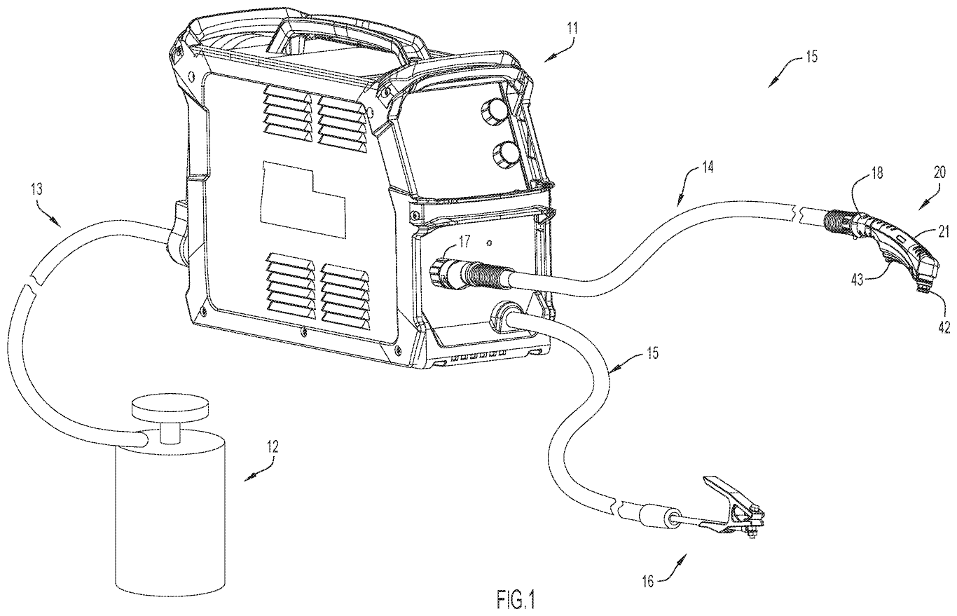

Various implementations of routing gas through a handle of a cutting torch or welding torch are disclosed. FIG. 1 illustrates an example plasma cutting system 10 in which the techniques presented herein may be carried out. The depicted cutting system 10 includes a power supply 11 that supplies power to a torch assembly 20. The power supply 11 also controls the flow of a process gas from a process gas supply 12 to the torch assembly 20 (however, in other implementations, the power supply 11 might supply the process gas itself). The torch assembly comprises a body 21 in which a majority of the operative parts of the torch assembly 20 are housed. The process gas supply 12 is connected to the power supply via cable hose 13 and the power supply 11 is connected to one or more gas conduits located in the torch body 21 via cable hose 14. The cutting system 10 also includes a working lead 15 with a grounding clamp 16 disposed at an end thereof.

Cable hose 13, cable hose 14, and/or working lead 15 may each include various conductors so that they may transmit data, electricity, signals, etc. between components of the cutting system 10 (e.g., between the power supply 11 and the torch assembly 20) and, as is illustrated, cable hose 13, cable hose 14, and/or working lead 15 may each be any length. In order to connect the aforementioned components of the cutting system 10, the opposing ends of cable hose 13, cable hose 14, and/or working lead 15 may each be coupled to the gas supply 12, power supply 11, torch assembly 20, or clamp 16 in any manner now known or developed hereafter (e.g., a releasable connection). The cable hose 14 may include a first connector 17 that releasably couples a first end of the cable hose 14 to a port of the power supply 11 and may also include a second connector 18 that releasably couples a second end of the cable hose 14 to a proximal end of the torch body 21. Thus, the torch body 21 may be releasably coupled to the power supply 11 via a releasable connection formed between the cable hose 14 and the power supply 11 and/or via a releasable connection formed between the cable hose 14 and the torch body 21.

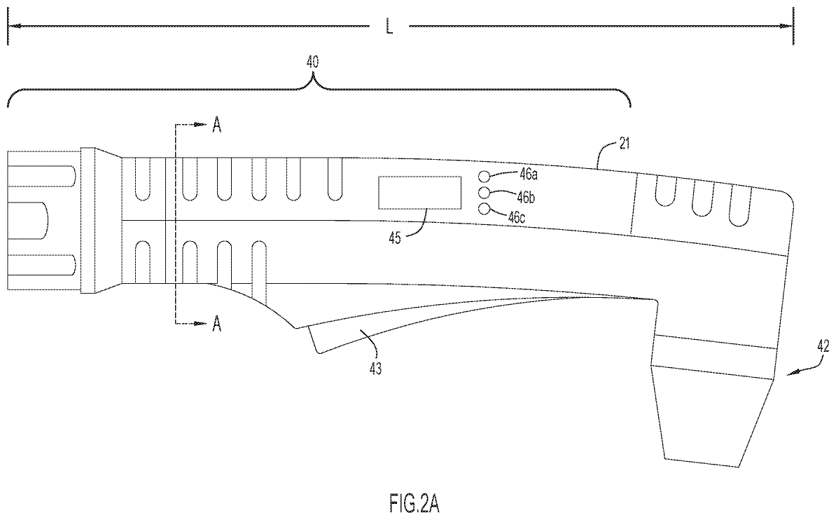

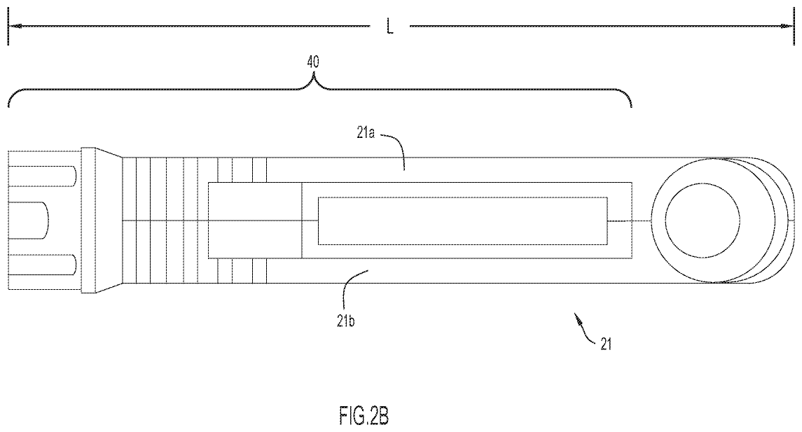

FIGS. 2A and 2B respectively illustrate a side view and a top view of the torch assembly 20 of FIG. 1. The torch assembly 20 includes body 21 that has a handle portion 40 that is configured to be gripped by the hand of a user of the torch. A head 42 of the torch protrudes from a distal end of the torch body 21. According to some implementations, the torch body 21 is made of two parts 20a and 20b having internal surfaces that, when fastened together as shown in FIGS. 2A, 2B, 4, 5B and 6, delimit an internal cavity 49, 149 and 249 in which electrical and mechanical components of the torch assembly 20 are housed. In the implementation of FIG. 2A, the torch assembly 20 includes a display 45 and various status indictors 46a, 46b and 46c that are presented on an outside of the torch body to provide to the user of the torch operational information before an initiation of or during a cutting operation. As shown in FIGS. 1 and 2A, the torch assembly 20 typically includes a trigger 43 that protrudes from a bottom side of the torch body 20. The trigger 43 is coupled to one or more electrical switches located inside the torch body 20 that are operatively coupled to one or more systems that control the flow of power and gas to the torch assembly.

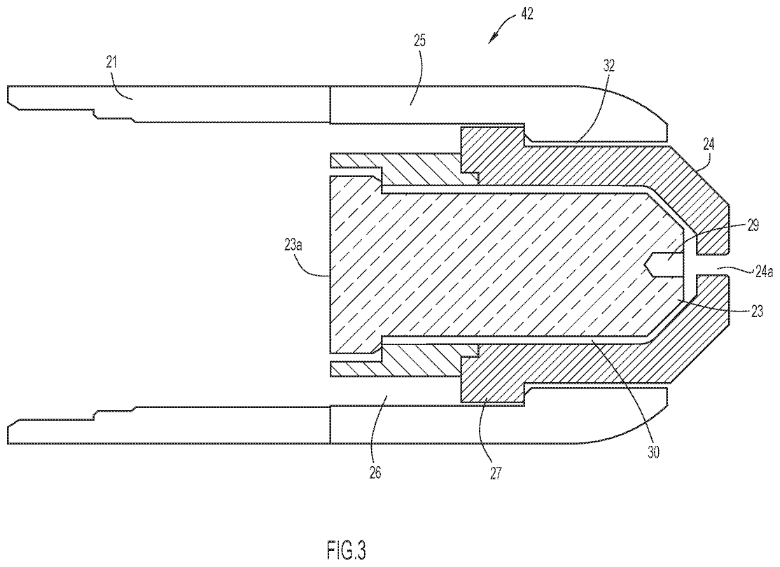

FIG. 3 illustrates the head 45 of a torch according to one implementation. For simplicity, only those features pertinent to the concepts of the present disclosure are illustrated. In the depicted implementation, the torch head 42 includes a number of consumable parts, such as, for example, an electrode 23, a nozzle 24, a shield cup 25 and gas distributor 26. A distal-most end of the nozzle 24 includes an orifice 24a. Located in a distal end portion of the electrode 23 is an emitter 29.

According to one implementation, after the electrode 23 and nozzle 24 are installed, the shield cup 25 is installed around an installation flange 27 of the nozzle 24 in order to secure the nozzle 24 and electrode 23 in place in axial alignment. Additionally or alternatively, the nozzle 24 and/or electrode 23 can be secured or affixed to the torch body 21 in any desirable manner, such as by mating threaded sections included on the torch body 21 with corresponding threads included on the components. For example, in some implementations, the electrode 23, nozzle 24, shield cup 25, gas distributor 26, as well as any other components (e.g., a lock ring, spacer, secondary cap, etc.) may be assembled together in a cartridge that may can be selectively coupled to the torch body 21. For example, the various components may be coupled to a cartridge body or coupled to each other to form a cartridge.

In use, the plasma torch assembly 20 is configured to emit a plasma arc between the electrode 23 and a workpiece to which the grounding clamp 16 is attached. As shown in FIG. 3, the torch tip 24 is spaced a distance away from the electrode 23 with there being a process gas flow channel 30 disposed between them. During initiation, power is first supplied to the nozzle 24 (anode) to generate an arc between the nozzle 24 and the electrode 23 (cathode) across the process gas flow channel 30. As process gas flows through channel 30 during arc initiation, it is ionized to form an electrically conductive plasma that is then directed out the orifice 24a of the nozzle 24 towards an electrically conductive workpiece (e.g. metal workpiece). Once this occurs, power (typically DC power) is supplied to the electrode 23 and an electrical circuit is established between the power source and a ground to which the workpiece is coupled via the grounding clamp 16. A plasma arc that closes the electrical circuit is thus established between the electrode 23 and the workpiece, the plasma arc being sufficient to cut through the workpiece by a localized melting of the material from which the workpiece is made. When power is supplied to the electrode 23, power to the nozzle 24 is terminated.

According to some implementations, when the plasma torch is equipped with the shield cap 25, a shield gas channel 32 is provided between the shield cap 25 and the outside of the nozzle 24 and is used to provide shielding gas at the cutting area of the workpiece to protect the cutting area from contaminates.

In traditional plasma cutting torches there is a space enclosed by the body of the torch preceding (located proximal to) the consumable parts that is typically densely populated with one or more conduits that direct process gas and shield gas respectively into channels 30 and 32. An additional conduit to deliver a cooling gas to cool a cooling surface 23a of the electrode 23 is sometimes also located in the space. These conduits have traditionally been spaced a distance away from an inner surface of the torch body 21. The space is furthermore occupied with electronics and electrical connectors (e.g. power and signal connectors) that are used to control current flow to the electrode 23 and to provide other functions (e.g. processing functions to control current and gas flows and indication functions to communicate to a user statuses associated with the torch assembly 20, the power supply 11, gas supply 12, etc.). The space is also typically occupied with mechanical elements, such as, for example, trigger components and internal supports to which the various aforestated items are secured.

To alleviate an overcrowding of components located in the space to make room for additional electronics and/or additional gas tubing inside the handle portion 40 of the torch body 21, disclosed herein are various implementations wherein one or more conduits for transporting gas are at least in part formed by a portion of the torch body 21. As will be discussed in more detail below, according to some implementations, an inner surface of a wall of the torch body 21 delimits an inner wall of the gas conduit, while in other implementations the entirety of the gas conduit is located inside a wall of the torch body 21. That is, the gas passage of the gas conduit is wholly integrated within the wall of the torch body 21 such that the resultant gas conduit and body 21 are singularly constructed (i.e. made from a single piece of material). In the latter case, the gas conduits may be formed in the course of a molding of the torch body 21.

According to some implementations, the one or more gas conduits are formed at least in part by the torch body 21 wall have a length that extends at least 25% of the length L of the torch body 21. According to other implementations, the one or more gas conduits have a length that extends at least 50% of the length L of the torch body 21.

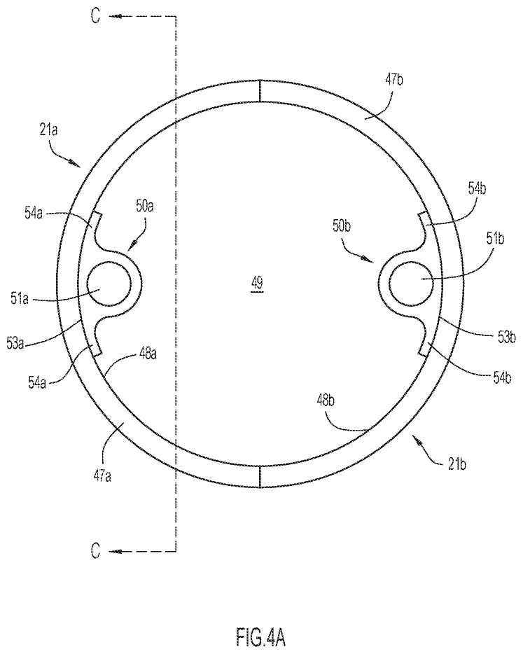

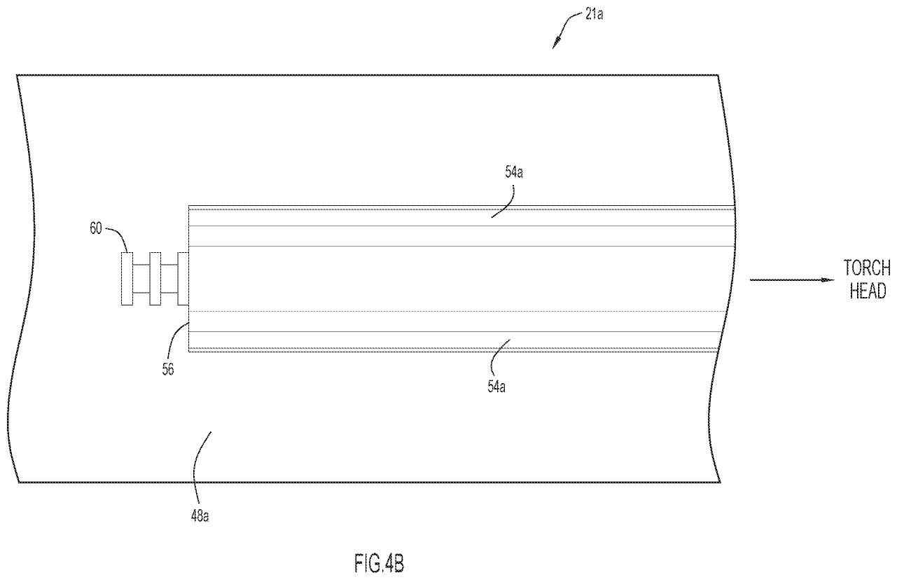

FIG. 4A depicts a cross-sectional view of the handle portion 40 of the torch body 21 of FIG. 2A along line A-A according to one implementation. In the implementation of FIG. 4A, the torch body 21 comprises first and second parts 21a and 21b that are shaped and attached to one another to form a central cavity 49 that extends along a length of the torch body. Each of the first and second parts 21a and 21b respectively includes first and second walls 47a and 47b that each in turn has an inner surface 48a and 48b. In the implementation of FIG. 4A, each of the first and second parts 21a and 21b has respectively attached to inner surface 48a and 48b, first and second gas conduit members 50a and 50b that each run along a length of the torch body 21. Each of the gas conduit members 50a and 50b respectively includes a longitudinal through passage 51a and 51b that is configured to transport gas.

In the example of FIG. 4A, each of the gas conduit members 50a and 50b respectively includes an external surface 53a and 53b that faces and is shaped to respectively conform to the internal surface 48a and 48b of the first and second torch body parts 21a and 21b. As shown in FIG. 4A, according to one implementation, each of the first and second gas conduit members 50a and 50b comprises flanges portions 54a and 54b that are provided to increase the effective surface area available for securing the gas conduit members to inner surfaces 48a and 48b. Each gas conduit member 50a and 50b can be attached to the first and second torch body parts with lost wax casting techniques, heat staking techniques, sonic welding, gluing, etc.

In the foregoing implementation each of the first and second parts 21a and 21b respectively includes attached to an inner surface thereof a gas conduit member 50a and 50b that transports gas along a length of the torch body. However, according to some implementations a single gas conduit member is provided attached to one of the first and second parts 21a and 21b of the torch body. According to other implementations, one or both of the first and second parts 21a and 21b of the torch body each includes two or more gas conduit members secured to their inner surfaces 48a and 48b.

FIG. 4B is a side view of the first part 21a of the torch body 21 shown in FIG. 4A along line C-C, with the proximal end 56 of the gas conduit 50a including a gas fitting 60 suitable for connecting the gas conduit passageway 51a to a gas supply, such as a gas supply tube located in cable tube 14. A like construction may also be implemented in the second part 21b of the torch body 21.

According to some implementations, each of the first and second gas conduit members 50a and 50b is unitarily constructed (i.e. made from a single piece of material). According to some implementations, each of the gas conduit members 50a and 50b comprises a polymer that is shaped using an injection molding process. Upon the gas conduit members being molded, they are thereafter attached to one or more inner surfaces of the torch body. According to other implementations, the gas conduit members 50a and 50b are constructed of metal by means of casting and/or machining processes.

In use, the gas conduits 50a and 50b are used to transport gases from a gas supply via cable hose 14 to one or both of process gas and shield gas channels 30 and 32 located in the head 42 of the torch 20.

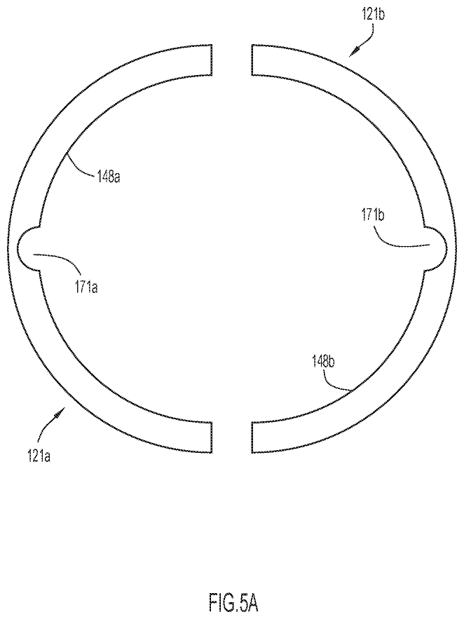

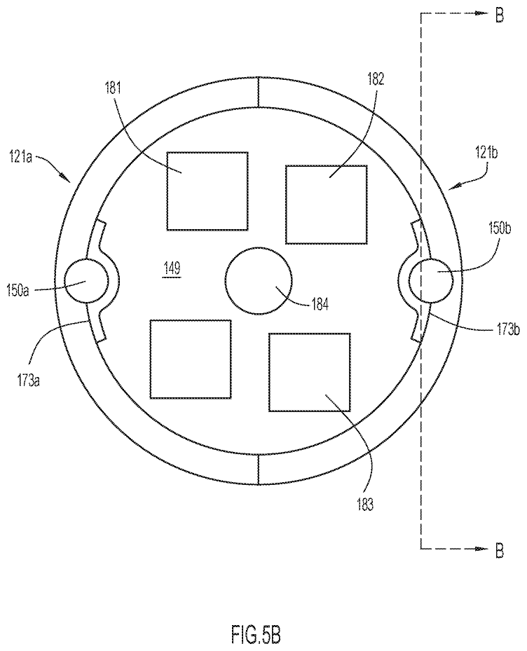

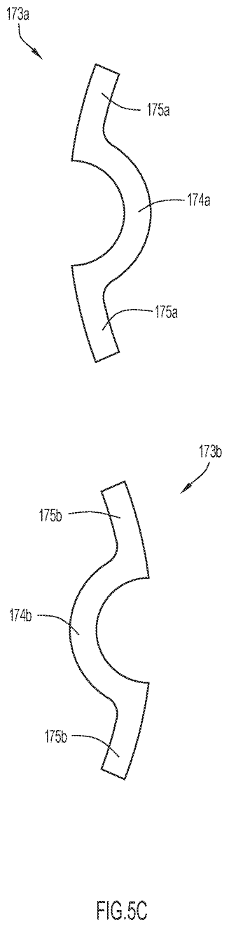

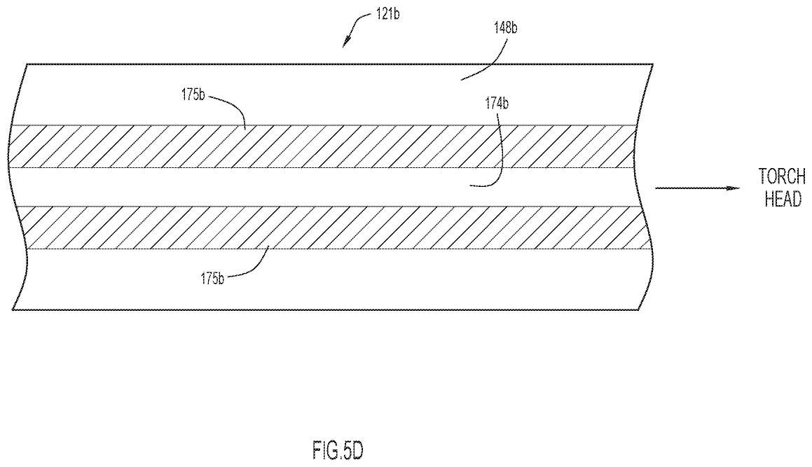

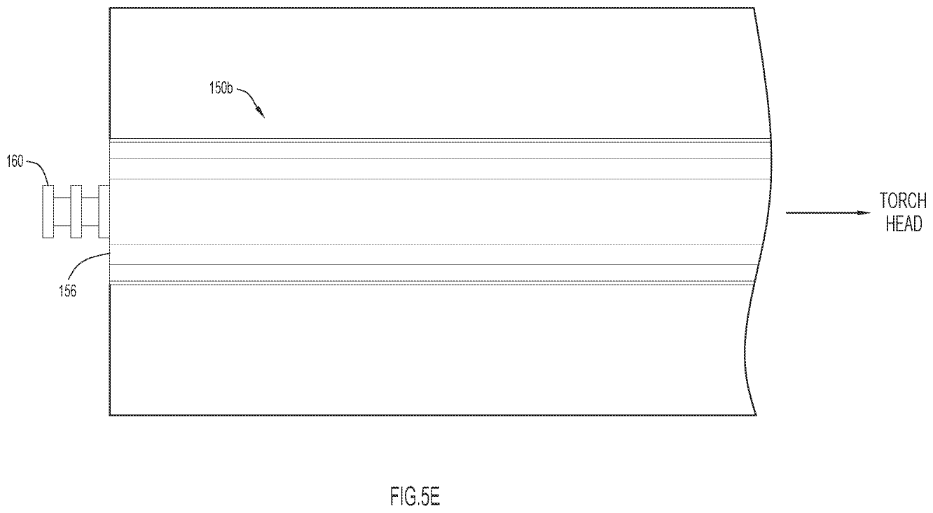

FIGS. 5A-E illustrate other implementations in which one or more gas conduits that deliver one or more gases towards or to the torch head 42 are formed in part by an inner surface of one or more walls of the torch body. In the examples that follow, the torch body 21 includes first and second parts 121a and 121b that are configured to be attached to one another. The first and second parts 121a and 121b are shaped such that an internal cavity 149 exists between them when the parts are assembled attached to one another. In the examples of FIGS. 5A-E, each of the first and second parts 121a and 121b of the torch body is equipped with a gas conduit 150a and 150b. However, according to other implementations, only one of the first and second parts 121a and 121b is equipped with a gas conduit or with multiple gas conduits. According to some implementations, each part 121a and 121b may each comprise multiple gas conduits.

According to one implementation, as shown in FIG. 5A, each body part 121a and 121b is a plastic molded part having formed along at least a portion of its length a groove 171a and 171b that is formed during the molding process. In the implementation of FIG. 5A and 5B, each of the grooves 171a and 171b has a semi-circular shape. According to other implementations the grooves may have a U-shape, a rectangular shape, etc. Prior to the torch body parts 121a and 121b being attached to one another to form the torch body 21, impervious members 173a and 173b are respectively secured to the inside surfaces 148a and 148b of parts 121a and 121b, respectively spanning across grooves 171a and 171b to form gas conduits 150a and 150b as shown in FIG. 5B. The impervious members may be made of a plastic, a metal, a composite material, etc. According to some implementations, each of the impervious members 173a and 173b includes a semi-circular portion 174a and 174b having an inner radius equal to the inner radius of respective grooves 171a and 171b. According to some implementations, extending from each side of semi-circular portion 174a and 174b are flange portions 175a and 175b that are used to secure the impervious parts to the inner surfaces of the first and second parts of the torch body 21. Each of the impervious member 173a and 173b may be attached to the torch body 21 with lost wax casting techniques, heat staking techniques, sonic welding, gluing, etc.

In the foregoing discussion, a cross-section of the gas passages of conduits 150a and 150b are disclosed to comprise a circular shape. However, according to other implementations the shape of the gas passages may comprise other shapes, such as, for example, semi-circular shapes, oval shapes, rectangular shapes, etc.

As shown in FIG. 5B, as a result of the gas conduits 150a and 150b being formed at least in part by inner walls of the tubular body 21, the volume of the central cavity 149 is greater than what would otherwise exists if of the gas conduits 150a and 150b were entirely located in the central cavity. As shown in FIG. 5B, according to some implementations, torch assembly components, such as one or more control circuits 181, one or more display circuits 182, trigger components 183, one or more gas conduits 184, etc. may be disposed between or radially inward of gas conduits 150a and 150b.

FIG. 5D shows a side view along lines B-B of FIG. 5B facing towards the inner surface 148b of the wall that forms the torch body part 121b, with the elongate impervious member 173b situated fix to the wall to form with the groove the gas conduit 150b.

FIG. 5E is a variant of the implementation of FIG. 5D, wherein a gas fitting 160 is fluidly coupled to the proximal end 156 of the gas conduit 150b.

In use, the gas conduits 150a and 150b are used to transport gases from a gas supply via cable hose 14 to one or both of process gas and shield gas channels 30 and 32 located in the head 42 of the torch 20.

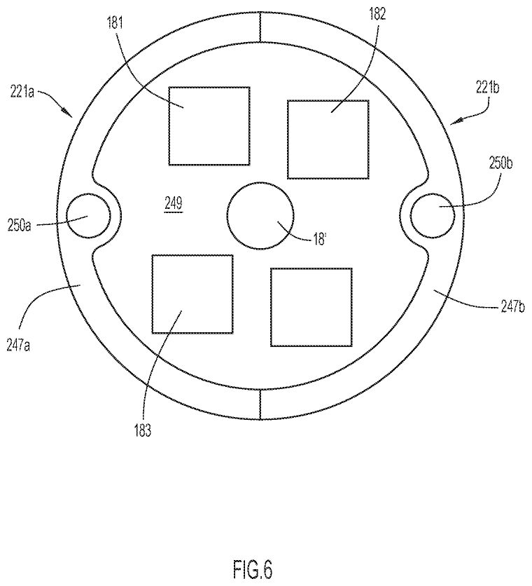

FIG. 6 is a cross-sectional view of a portion of the plasma torch of FIG. 2A along line A-A according to another implementation, wherein gas conduits 250a and 250b are formed entirely within the wall that forms the torch body. Like the implementations disclosed above, according to some implementations the torch body 21 comprises first and second parts 221a and 221b that are formed separately (e.g. via injection molding processes) and later attached together as shown in FIG. 6. Alternatively, the torch body 21 may comprise a unitary structure that is formed by injection molding. The torch of FIG. 6 distinguishes from the previously disclosed implementations in that gas conduits 250a and 250b are encased within the walls 247a and 247b of the torch body. In use, the gas conduits 250a and 250b are used to transport gases from a gas supply via cable hose 14 to one or both of process gas and shield gas channels 30 and 32 located in the head 42 of the torch 20.

As shown in FIG. 6, according to some implementations, torch assembly components, such as one or more control circuit's 181, one or more display circuits 182, trigger components 183, one or more gas conduits 184, etc. may be disposed between or radially inward of gas conduits 250a and 250b.

According to some implementations, the torch body 21 includes a single gas conduit encased within it. According to other implementations, the torch body 21 includes greater than two gas conduits encased within it.

In regard to each of the implementations disclosed and contemplated above, an additional advantage of the placement of the gas conduits is that they are well situated to cause a cooling of the torch handle as gas is passed through them. According to some implementations, in order to increase the effective cooling area, one or more of the gas conduits are formed to run along a length of the torch body handle in an undulating or spiral fashion. In addition, in instances in which multiple gas conduits are used, the gas conduits may be connected to a common supply source (e.g. a gas tube extending through cable hose 14) via a splitter.

The previous examples are not suggested to limit other variations. The present disclosure is merely exemplary in nature and, thus, variations that do not depart from the spirit of the disclosure are intended to be within the scope of the present disclosure.

What is claimed is:

1. A plasma torch for cutting a workpiece, the plasma torch comprising:
an electrode having an external surface;
a nozzle having an internal surface that at least partially surrounds the electrode;
a process gas flow channel located between the external surface of the electrode and the internal surface of the nozzle;
a torch body to which the electrode and nozzle are coupled, the torch body comprising a wall having an external surface and an internal surface, the external surface configured for being gripped by a hand of a human user, the internal surface defining an internal space of the torch body occupied by electrical components and mechanical components necessary for operating the plasma torch; and
a first gas conduit having a longitudinal length formed at least in part by a first part of the internal surface of the wall of the torch body.

2. The plasma torch according to claim 1, wherein the first gas conduit is fluidly coupled to the process gas flow channel located between the electrode and the nozzle.

3. The plasma torch according to claim 1, wherein the first part of the internal surface comprises a recess in the wall of the torch body.

4. The plasma torch according to claim 3, wherein the recess has a semi-circular shape.

5. The plasma torch according to claim 1, further comprising a shield cap and a shield gas flow channel located between an internal surface of the shield cap and an external surface of the nozzle, the first gas conduit being fluidly coupled to the shield gas flow channel.

6. The plasma torch according to claim 2, further comprising:
a shield cap and a shield gas flow channel located between an internal surface of the shield cap and an external surface of the nozzle; and
a second gas conduit having a longitudinal length formed in part by a second part of the internal surface of the wall of the torch body, the second gas conduit being fluidly coupled to the shield gas flow channel.

7. The plasma torch according to claim 1, wherein the longitudinal length of the first gas conduit is further formed by a first impervious member that is bonded to the plasma torch body and lies over the first part.

8. The plasma torch according to claim 7, wherein the first impervious member includes a longitudinal recess that faces the first part.

9. The plasma torch according to claim 6, wherein the longitudinal length of the first gas conduit is further formed by a first impervious member that lies over the first part, and the longitudinal length of the second gas conduit is further formed by a second impervious member that is bonded to the torch body and lies over the second part.

10. The plasma torch according to claim 9, wherein the first impervious member includes a longitudinal recess that faces the first part, and the second impervious member includes a longitudinal recess that faces the second part.

11. The plasma torch according to claim 2, further comprising:
a shield cap and a shield gas flow channel located between an internal surface of the shield cap and an external surface of the nozzle;
a shield gas conduit located in the internal space of the plasma body, the shield gas conduit being spaced a distance away from the internal surface of the wall of the torch body.

12. The plasma torch according to claim 5, further comprising a process gas conduit located in the internal space of the torch body, the process gas conduit being spaced a distance away from the internal surface of the torch body and being fluidly coupled to the process gas flow channel located between the external surface of the electrode and the internal surface of the nozzle.

13. The plasma torch according to claim 1. further comprising a second gas conduit having a longitudinal length and located in the internal space of the torch body, the second gas conduit being spaced a distance away from the internal surface of the wall of the torch body.

14. The plasma torch according to claim 13, further comprising a third gas conduit having a longitudinal length formed in part by a second part of the internal surface of the wall of the torch body.

15. The plasma torch according to claim 13, wherein one of the first and second gas conduits is arranged to carry a process gas and the other of the first and second conduits is arranged to carry a shield gas or a cooling gas.

16. The plasma torch according to claim 14, wherein the first and second gas conduits are respectively arranged to carry a process gas and a shield gas, and the third conduit is arranged to carry a cooling gas toward a cooling surface of the electrode.

17. A plasma torch used for cutting a workpiece, the plasma torch comprising:
an electrode having an external surface;
a nozzle having an internal surface that at least partially surrounds the electrode;
a process gas flow channel located between the external surface of the electrode and the internal surface of the nozzle;
a torch body to which the electrode and nozzle are coupled, the torch body comprising a wall having an external surface and an internal surface, the external surface configured for being gripped by a hand of a human user, the internal surface defining an internal space of the torch body occupied by electrical components and mechanical components necessary for operating the plasma torch; and
a first gas conduit having a longitudinal length formed entirely inside the wall of the torch body, the first gas conduit and torch body comprising a single structure made of a single piece of material.

18. The plasma torch according to claim 17. further comprising a second gas conduit having a longitudinal length and located in the internal space of the torch body, the second gas conduit being spaced a distance away from the internal surface of the wall of the torch body.

19. The plasma torch according to claim 18, further comprising a third gas conduit having a longitudinal length encased inside the wall of the torch body, the third gas conduit and torch body comprising a single structure made of a single piece of material.

20. The plasma torch according to claim 18, wherein one of the first and second gas conduits is arranged to carry a process gas and the other of the first and second conduits is arranged to carry a shield gas or a cooling gas.

21. The plasma torch according to claim 19, wherein the first and second gas conduits are respectively arranged to carry a process gas and a shield gas, and the third conduit is arranged to carry a cooling gas toward a cooling surface of the electrode.
